(19) United States
(12) Patent Application Publication
(10) Pub. No.: US 2022/0087482 A1
(43) Pub. Date: Mar. 24, 2022

(54) Apparatus for Making Sugar on Snow and Brewing Coffee and Tea

(71) Applicant: Connor Whitenack, Morristown, NJ (US)

(72) Inventor: Connor Whitenack, Morristown, NJ (US)

(21) Appl. No.: 17/031,441

(22) Filed: Sep. 24, 2020

(51) Int. Cl. A47J 47/01

(52) U.S. Cl. CPC A47J 47/01

(57) ABSTRACT

A metal basin was designed for preparing syrups for use in ‘sugar on snow’ as well as utilize remnants in additional recipes such as coffee or tea. The invention has a geometry that is capable of pouring viscous materials into long, thin strips and filter sediments suspended in a liquid. The invention can be used to the discretion of its operator and is not bound to perform only the tasks specified or in any particular order.

### BACKGROUND

‘Sugar on snow’ is a traditional Canadian dessert dish formed by pouring strips of hot maple syrup directly onto a cold medium, usually fresh snow. The sudden change in temperature causes the maple syrup to thicken into a hard, chewy candy that can be eaten. Historically, the dish has been referred by many different titles, depending on region and customs. Examples include “Maple taffy”, “Leather aprons”, or “Candy on snow” in English-speaking Canada and New England and “Tire d'érable” or “Tire sur la neige” in French-speaking Canada.

The method for creating ‘sugar on snow’ is simple and can be completed using standard a kitchen stove, pot, and ladle. Maple syrup is allowed to settle in a container, usually a metal pot, and brought to a boil in the region of 105° C. to 130° C. Stirring is not recommended as it can cause the maple syrup to crystallize and form grains. Once the syrup is heated to the appropriate temperature, it is quickly poured onto a cold medium, which causes to syrup to thicken. A cold medium can include, but is not limited to snow, ice, ice cream, and other frozen desserts. Ideally, the syrup is poured in long, thin strips to maximize contact area and improve cooling. The hotter the syrup is prior to pouring, the thicker the resulting candy will be. Once the syrup has cooled and hardened on the cold medium, it can be lifted off using a tool such as a wooden popsicle stick or a metal fork. It is at this point that the Tire d'erable is consumed and enjoyed. ‘Sugar on snow’ is commonly made and consumed with other foods such as donuts or coffee.

After ‘sugar on snow’ has been prepared, it is assumed that the pot that was used will have some remaining syrup lining the interior. At this point, the left-over syrup would typically be washed out of the pot, but the enduring syrup can be used in other recipes. Adding water to the pot will create a solution that can be used as a substitute in recipes calling for both water and sugar. The flavor of maple syrup will be instilled in the succeeding recipe and can be used in a variation of ways. Possible recipes include, but are not limited to coffee, tea, whipped cream, and pancakes.

In the case of preparing coffee or tea, one would follow this procedure to incorporate the left-over maple syrup from a batch of ‘sugar on snow’. With the pot still containing the maple syrup residue, add water and bring to a boil while stirring. At this point, the water can easily be brewed into tea or coffee by infusing tea leaves or coffee grounds and allowed to steep. Before serving, the water must have the tea leaves or coffee grounds removed, otherwise the final beverage will contain sediments and be ruined.

One method of removing sediments is to use a filter to separate the particulate from the liquid. Tea is generally manufactured inside its own filter to solve this problem, otherwise a conventional ‘coffee filter’ can be used to strain the particulate from the beverage. Another method of removing sediments is to stabilize the pot and allow the particulate to settle to bottom. Without disturbing the deposits, the water can be carefully poured out into a separate container, ceasing immediately before the sediments begin to flow out of the pot.

This practice makes it easy to utilize the waste of one recipe by incorporating it into another. This case being; making use of leftover syrup residue from a batch of ‘sugar on snow’ in a complimentary beverage. Not only does it repurpose ingredients that would otherwise be discarded, but it reduces the total equipment used to prepare each recipe. Preparing both recipes in conjunction requires the use of only one vessel.

### SUMMARY

A vessel that has the capability of heating and preparing maple syrup for use in ‘sugar on snow’.
A vessel that can boil water and preparing solutions for unlimited applications or recipes.
A form that allows for the pouring of viscous materials into long, thin strips to reduce cooling times.
A form that allows the filtration of settled particles from a liquid being transferred into an additional vessel.
A form that allows the measurement of volumes contained within a vessel in standardized units.

### BRIEF DESCRIPTION OF THE DRAWINGS

FIG. 1 shows a conductive metal basin used in the boiling of liquids and viscous material.

FIG. 2 details the widened spout used for pouring liquids and viscous materials into long, thin strips.

FIG. 3 details the horizontal channels or ‘sluice’ used in the removal of settled sediment from a liquid or viscous material being poured from the basin.

FIG. 4 is a cut section of the ‘sluice’ used in the filtration of sediments from the liquid contained in the basin.

FIG. 5 displays the integrated measurement marks with each protrusion signifying consecutive 50 milliliter levels.

FIG. 6 is a side view of a basin that is suitable for the production of Sugar on Snow.

### DETAILED DESCRIPTION

The inventor provides a heat conducting form capable of properly preparing maple syrup for use in ‘sugar on snow’ as well as boiling water and its solutes. The form includes the necessary attributes to produce recipes precisely and consistently. The present invention is described in enabling detail in the following examples, which may represent more than one embodiment of the present invention.

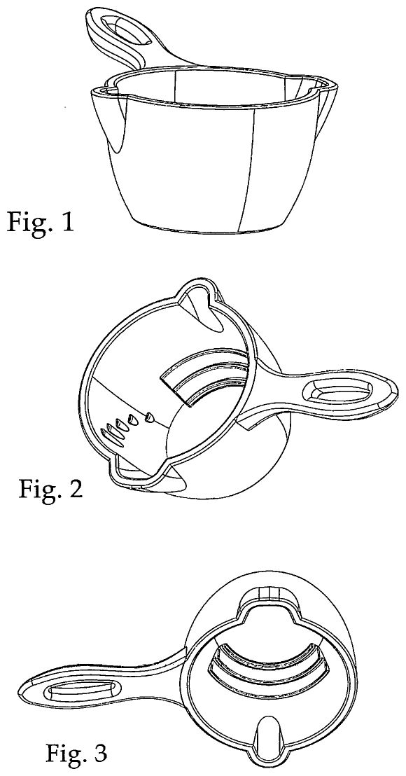

The principal objective of the invention is to properly produce a batch of ‘sugar on snow’. As described in the background, ‘sugar on snow is a dessert dish prepared by pouring a strip of near-boiling maple syrup directly onto a cold medium. The syrup will solidify on the cold medium at which point it may be consumed. As an additional objective, the invention can be used to prepare coffee or tea within the same form. FIG. 1 shows the stated invention and its form used to complete the tasks required for preparing various recipes.

The proper preparation of recipes requires a degree of accuracy and precision in measurement. A form of quantification is necessary if the invention is to produce recipes with any sort of consistency. Ordinarily, volumes are measures with standardized markings on the surface of a transparent container. The volume of the liquid being measured would be calculated by referencing the meniscus with the closest mark on the container. Given that the basin is constructed of metal, ordinary volume measurement markings could not function as metal is not transparent. To rectify this problem, small indents protrude from the interior of the basin to denote standardized levels. This method can be used in both imperial and metric measurement systems.

Used in conjunction with a heating element such as a stovetop, the invention transfers heat through its body into the liquid or viscous material contained within it. Moreover, the body is structured to retain heat once it has been removed from the heating element. Its rounded body made of solid metal minimizes exposed surface area and insulates the material being prepared. This is necessary when transporting material from the heating element to the cold medium or a separate container. Premature cooling could result in delays or overall failure of preparation.

Though cooling is discouraged to occur prior to pouring, cooling is desired once the syrup makes contact with the cold medium. The action of pouring hot maple syrup onto a cold medium will result in the syrup hardening to a viscous state that of which can be interacted with as a semi-solid. The best way to decrease cooling time is to increase the surface area the syrup has to the cold medium. For ‘sugar on snow’, it is traditional to pour the syrup as a continuous strip rather than into a puddle or to empty the basin without any forethought or order. The idea is to form a shape that is thin enough to enhance cooling, but thick enough to be picked up without shattering. Pouring all the contents onto a single point would create a puddle that is difficult to cool with any consistency and would result in a puddle of syrup. Tossing the contents out of the basin would result in a product that is varying in viscosity and prone to shattering where it was poured too thin. With a long thin strip, the syrup can cool in uniform to a consistency that is hard enough interact as a solid, but soft enough to be pliable and supple like a viscous. Thick enough to hold its shape as a pliable viscous and thin enough to cool quickly and harden.

The form as displayed in FIG. 2 shows the wide mouth spout designed for pouring syrups into long, thin strips. The spout is specifically widened to allow the flow of syrup to exit the basin in an oblong cross section, rather than the conventional circular or triangular cross section. A steady pour will result in a tidy, swathe of syrup with rounded corners and a uniform cross section throughout. This is the optimal shape for producing ‘sugar on snow’. Once the syrup has formed to a viscous, the long, thin strip is the easiest to be worked into its final, edible form. The strip can be grasped as and enjoyed in its current form without any further modification or tools. Though traditionally, ‘sugar on snow’ is removed from the cold medium using a popsicle stick, using it to roll the viscous into a spiral wheel shape. This also creates a convenient and portable handle at which to hold the dessert without getting syrup on the user's hands or garments.

Once the maple syrup has been removed from the basin to produce ‘sugar on snow’, there will remain some syrup residue on the faces of the interior. This will accumulate towards the bottom and will remain until it is washed out using water. Typically, when removing the residue, the water used to rinse the basin would be discarded and otherwise wasted. But the syrup-water solution is far from worthless or inedible. Given that so many recipes, too many to list in any manner, contain both sugar and water, it would make sense to reincorporate the solution into a succeeding recipe. The most obvious and popular recipe to embrace this mixture would be coffee or tea. Both recipes are comprised mostly of water and it is common to sweeten either drink using sugar of some form, whether it be cane sugar, maple syrup, honey, molasses, et cetera. Using the same basin that was used to produce ‘sugar on snow’, a subsequent recipe such as coffee or tea can be composed.

Preparing coffee or tea in the invention is very similar to producing a batch of ‘sugar on snow’. Either beverage can be produced in the invention whether syrup residue lines the interior of the basin or not. The syrup residue is simply used to sweeten the final drink and is left to the discretion and the tastes of the individual using the invention. The primary ingredient of water is added to the basin and is heated to boiling temperature with the use of a heating element or stove. For tea, the heat is removed, and tea leaves are submerged directly in the basin. Most commonly, tea is prepared using a tea bag filter, a strainer, or with loose leaf. After some time to brew, the tea leaves are extracted from the water by removing the tea bag or strainer from the water or by scooping the loose leaf from the water with a spoon or a fork. Tea leaves that settle towards the bottom of the basin can also be filtered from the water using the invention's sluice, which will be described in further detail shortly. The tea can then be poured into a mug or glass and consumed.

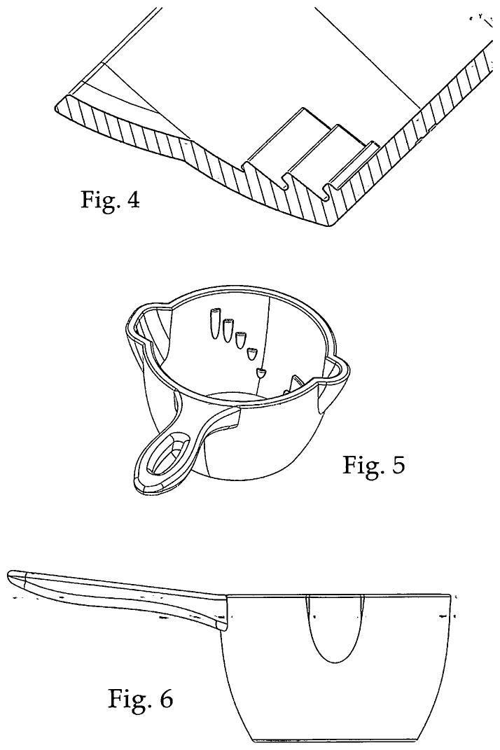

Producing coffee in the invention is very similar to making tea, though varies slightly. The basin is filled with water and brought to a rolling boil using a heating element. Now, rather than removing the heat, the water is left to boil while ground coffee is introduced directly into the water and allowed to brew. After brewing, the heat is removed. Before consuming, the ground coffee must be filtered from the water or else the beverage will contain unwanted sediment, become too acidic, and be otherwise mined. The invention does not require any secondary filtering process to produce coffee and makes use of the invention's ‘sluice’ to filter the coffee out of the water and is detailed in FIG. 4.

A sluice is a series of channels that removes particles from liquids flowing over it. The channels, also referred to as riffles, create a swirling effect and low-pressure zones within the low points of the riffles. These low-pressure zones pull sediments from the liquid and hold them until liquid seizes to flow. This method is commonly used in placer mining for gold and is very efficient in separating particulate of heavy solids, like gold, from the liquid they are suspended in. Miners typically send running stream water through the sluice along with river sediment to uncover hidden gold particles.

Removing ground coffee from the water it was brewed in is very similar to pulling gold from the stream it was concealed in. After removing the heat, the water that was brought to a rolling boil will stabilize and the coffee ground will have a chance to fall to the bottom of the basin. Grounds can be encouraged to settle towards the bottom of the basin by adding a small amount of cold water to the boiling water or by submerging a cold utensil for a moment. With the grounds settled, the coffee can be filtered using the sluice and slowly poured into a mug or a glass. By pouring slowly, only brewed coffee will exit from the top of the basin and the sluice will hold onto the sediment. As the basin nears emptying, some grounds will start to flow towards the spout, at which point the pouring must be concluded. The final beverage will not have any sediments or contaminates and can be consumed.

The handle joined to the basin provides a point of control in which the invention can be utilized. The grip allows users to properly carry, tilt, or otherwise make use of the stated invention when transporting or preparing recipes. The handle intentionally features a slot which can be used to hang the invention on a hook or nail, whether as a method of storage or display. The slot can also be used in the transportation of the invention and can be tied off with a cord or chain, as well as accommodate shackles, clips, carabiners, or other popular securing methods.

The handle's slight angle upwards allows the basin to be placed upside down onto a surface without creating a seal. Liquids remaining inside the basin have an opening in which to escape. This is also important in the case that the hot basin is placed upside down on a solid surface. The cooling of the air inside basin could create a suction effect, locking the basin to the surface. Exposing the interior by propping up the basin with the handle eliminates this risk.

This invention is designed to efficiently produce ‘sugar on snow’, coffee or tea, or any combination of the three. It is also capable of producing other complimentary recipes such as simple syrup, whipped cream, and any other recipe that incorporates sugar and water. It is also noted that ‘sugar on snow’ can also be directly combined to coffee or tea to the user's discretion. The popsicle stick used to pick the ‘sugar on snow’ from the cold medium can subsequently be used as a beverage stirrer thus furthering the association between the recipes. This invention contains the necessary features and geometries to produce ‘sugar on snow’, coffee or tea, or other recipes with minimal wasted ingredients and minimal equipment.

1. An apparatus that is capable of producing ‘sugar on snow’, coffee, and tea, among other recipes.
A form in which to pour viscous materials into long, thin strips onto the surface of a cold medium.
